(19) United States
(12) Patent Application Publication
(10) Pub. No.: US 2015/0137779 A1
(43) Pub. Date: May 21, 2015

(54) MATRIX CONVERTER AND METHOD FOR CONTROLLING MATRIX CONVERTER

(71) Applicant: KABUSHIKI KAISHA YASKAWA DENKI, Kitakyushu-shi (JP)

(72) Inventors: Yoshiyasu TAKASE, Fukuoka (JP); Hidenori HARA, Fukuoka (JP); Shinya MORIMOTO, Fukuoka (JP)

(73) Assignee: KABUSHIKI KAISHA YASKAWA DENKI, Kitakyushu-shi (JP)

(21) Appl. No.: 14/604,756

(22) Filed: Jan. 26, 2015

Related U.S. Application Data
(63) Continuation of application No. PCT/JP2012/069483, filed on Jul. 31, 2012.

(51) Int. Cl. H02M 3/158

(52) U.S. Cl. CPC H02M 3/158
USPC 323/273

(57) ABSTRACT

A matrix converter according to an embodiment includes a plurality of bidirectional switches disposed between an AC power source and an AC load, and a controller that controls the bidirectional switches. The controller corrects an output voltage reference based on an oscillation component of an input current and/or an input voltage from the AC power source.

### CROSS-REFERENCE TO RELATED APPLICATION

This application is a continuation of PCT international application Ser. No. PCT/JP2012/069483 filed on Jul. 31, 2012 which designates the United States; the entire contents of which are incorporated herein by reference.

### FIELD

The disclosed embodiments relate to a matrix converter.

### BACKGROUND

Conventionally, there is known a matrix converter that converts power of an alternating current (AC) power source directly into AC power of an arbitrary frequency and voltage.

In such a matrix converter, a large energy buffer does not exist, as compared with a conventional AC-AC power conversion apparatus combining an AC-DC power converter with a DC-AC power converter.

Therefore, when the matrix converter is operated in a state where an input voltage is distorted, an input current and an output voltage are distorted. As a technique for solving the problem regarding such distortion of an input voltage, there is known a technique for reducing distortion of an output voltage by performing control to distort an input current (see Japanese Patent Application Laid-open No. 2005-269805, for example).

The technique described in the patent application aims at reducing distortion of an output voltage, for a problem in which when a distorted output voltage is supplied to an electric motor, a trickle ripple occurs in the electric motor and causes noise.

However, as a use of the matrix converter, some uses have a problem in distortion of an input current rather than in occurrence of a trickle ripple in the electric motor. In such uses, it may be more effective to reduce distortion of an input current than to reduce distortion of an output voltage.

### SUMMARY

A matrix converter according to an embodiment includes a plurality of bidirectional switches and a controller. The plurality of bidirectional switches are disposed between an AC power source and an AC load. The controller controls the bidirectional switches to directly convert input power input from the AC power source into an output power to be output to the AC load. The controller includes an output voltage reference generator, a corrector and a switch driver. The output voltage reference generator generates an output voltage reference defining an output voltage to be output to the AC load. The corrector corrects the output voltage reference based on an oscillation component of an input current and/or an input voltage input from the AC power source. The switch driver controls the bidirectional switches based on the output voltage reference corrected by the corrector.

### BRIEF DESCRIPTION OF DRAWINGS

A more complete appreciation of the invention and many of the attendant advantages thereof will be readily obtained as the same becomes better understood by reference to the following detailed description when considered in connection with the accompanying drawings, wherein:

FIG. 1 is a diagram illustrating a configuration example of a matrix converter according to a first embodiment;

FIG. 2 is a diagram illustrating an example of a bidirectional switch illustrated in FIG. 1;

FIG. 3 is a diagram illustrating a configuration example of a controller of the matrix converter according to the first embodiment;

FIG. 4 is a diagram illustrating a configuration example of a controller of a matrix converter according to a second embodiment;

FIG. 5 is a diagram illustrating a configuration example of a controller of a matrix converter according to a third embodiment;

FIG. 6 is a diagram illustrating a configuration example of a controller of a matrix converter according to a fourth embodiment; and

FIG. 7 is a diagram illustrating a configuration example of a controller of a matrix converter according to a fifth embodiment.

### DESCRIPTION OF EMBODIMENT

In the following, embodiments of the matrix converter disclosed in this application will be described in detail with reference to the attached drawings. Note that the embodiments described in the following do not limit the invention.

### First Embodiment

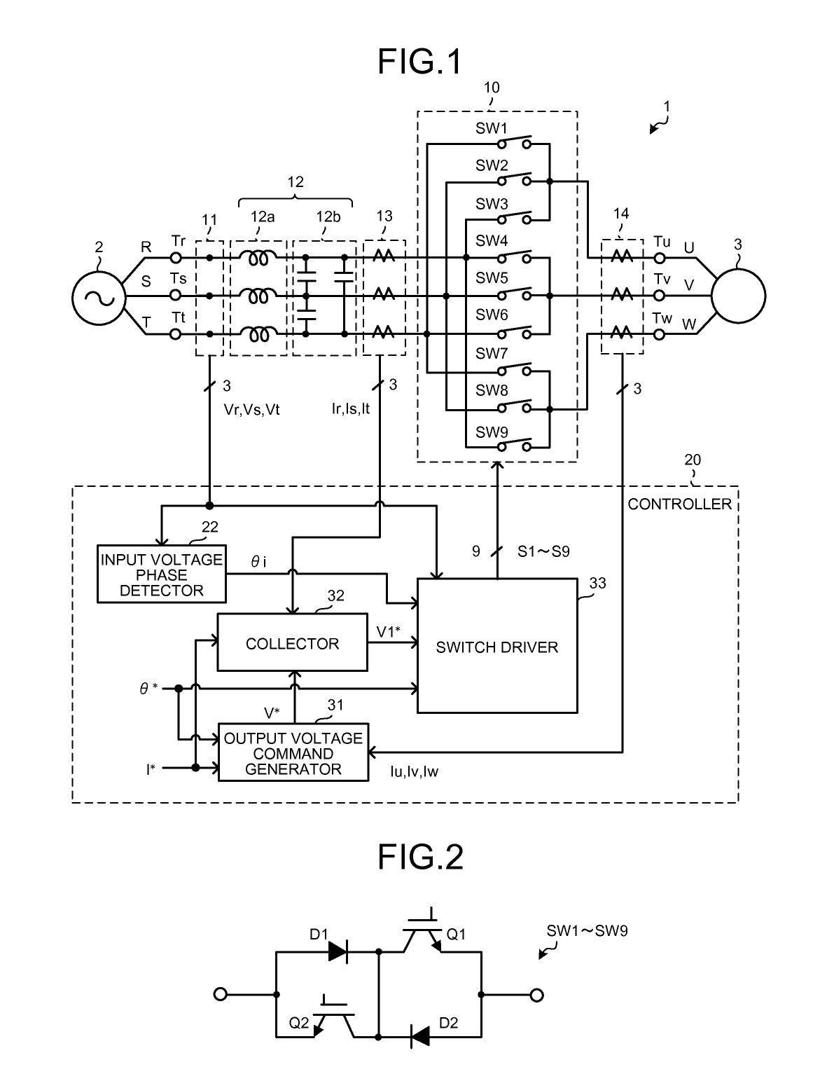

FIG. 1 is a diagram illustrating a configuration example of a matrix converter according to the first embodiment. As illustrated in FIG. 1, a matrix converter 1 according to the first embodiment has input terminals Tr, Ts, Tt and output terminals Tu, Tv, Tw. Respective phases of a three-phase AC power source 2 are connected to the input terminals Tr, Ts, Tt, and respective phases of an AC load 3 are connected to the output terminals Tu, Tv, Tw.

The matrix converter 1 converts AC power input from the three-phase AC power source 2 directly into AC power of a predetermined voltage and frequency and outputs the AC power to the AC load 3. The three-phase AC power source 2 is a power supply facility or an AC power generator that transforms and supplies a voltage of a power system, for example, and the AC load 3 is an AC electric motor, for example. Note that the matrix converter 1 can perform power conversion from the three-phase AC power source 2 to the AC load 3 and, in addition, it can also perform power conversion from the side of the AC load 3 to the side of the three-phase AC power source 2.

The matrix converter 1 has a power conversion unit 10, an input voltage detector 11, an input filter 12, an input current detector 13, an output current detector 14, and a controller 20, as illustrated in FIG. 1.

The power conversion unit 10 has a plurality of bidirectional switches SW1 to SW9 that connect phases of the three-phase AC power source 2 and phases of the AC load 3. The bidirectional switches SW1 to SW3 connect each of an R phase, an S phase, and a T phase of the three-phase AC power source 2 with a U phase of the AC load 3. The bidirectional switches SW4 to SW6 connect each of the R phase, the S phase, and the T phase of the three-phase AC power source 2 with a V phase of the AC load 3. The bidirectional switches SW7 to SW9 connect each of the R phase, the S phase, and the T phase of the three-phase AC power source 2 with a W phase of the AC load 3.

The bidirectional switches SW1 to SW9 can be constituted by diodes D1, D2, and one-directional switching elements Q1, Q2, for example, as illustrated in FIG. 2. FIG. 2 is a diagram illustrating an example of the bidirectional switches SW1 to SW9 illustrated in FIG. 1. As the switching elements Q1, Q2, semiconductor switches such as insulated gate bipolar transistors (IGBTs) are used, for example.

Signals are input to gates of such semiconductor switches to turn on/off each semiconductor switch, whereby the conduction direction is controlled. Note that the bidirectional switches SW1 to SW9 are not limited to the configuration illustrated in FIG. 2, and may be a configuration in which one-directional switching elements are connected in parallel in directions opposite to each other.

The input voltage detector 11 detects a voltage input to the matrix converter 1 from the three-phase AC power source 2 (hereinafter described as an input voltage). To be more specific, the input voltage detector 11 detects instantaneous values Vr, Vs, Vt of phase voltages of the three-phase AC power source 2 (hereinafter described as input voltage values Vr, Vs, Vt). Note that the input voltage detector 11 is not limited to what is illustrated in FIG. 1, and may be configured to detect a value of a line voltage of two phases among input phases and calculate input voltage values Vr, Vs, Vt based on such a value of the line voltage, so as to detect an input voltage.

The input filter 12 has a reactor unit 12a and a capacitor unit 12b, and removes higher harmonics due to switching of the bidirectional switches SW1 to SW9. The reactor unit 12a has three reactors provided between each of the R phase, the S phase, and the T phase of the three-phase AC power source 2 and the power conversion unit 10. Moreover, the capacitor unit 12b has three capacitors disposed between the R phase and the S phase, between the S phase and the T phase, and between the T phase and the R phase, respectively. Note that although the capacitor unit 12b has a delta connection configuration in the example illustrated in FIG. 1, it may have a star connection configuration. That is, the capacitor unit 12b may have a configuration in which capacitors are connected between each of the R phase, the S phase, and the T phase and a neutral point.

The input current detector 13 detects a current flowing between the input filter 12 and the power conversion unit 10. To be more specific, the input current detector 13 detects instantaneous values Ir, Is, It of currents flowing between each of the R phase, the S phase, and the T phase of the three-phase AC power source 2 and the power conversion unit 10 (hereinafter described as input current values Ir, Is, It). Note that the input current detector 13 is a current sensor that detects a current using a hall element that is an electromagnetic conversion element, for example.

The output current detector 14 detects a current flowing between the power conversion unit 10 and the AC load 3. To be more specific, the output current detector 14 detects instantaneous values Iu, Iv, Iw of currents flowing between the power conversion unit 10 and each of the U phase, the V phase, and the W phase of the AC load 3 (hereinafter described as output current values Iu, Iv, Iw). Note that the output current detector 14 is a current sensor that detects a current using a hall element that is an electromagnetic conversion element, for example.

The controller 20 has an output voltage reference generator 31, a corrector 32, a switch driver 33, and an input voltage phase detector 22. The controller 20 generates drive signals S1 to S9 based on detection results of the input voltage detector 11, the input current detector 13, and the output current detector 14, and controls the bidirectional switches SW1 to SW9 of the power conversion unit 10. The drive signals S1 to S9 are PWM signals, for example.

The output voltage reference generator 31 generates an output voltage reference V* defining an output voltage to be output to the AC load 3 based on an output current reference I* defining an output current to be output to the AC load 3 and the output current values Iu, Iv, Iw detected by the output current detector 14. The output voltage reference generator 31 outputs the output voltage reference V* to the corrector 32.

The corrector 32 extracts an oscillation component of the input current based on the input current values Ir, Is, It detected by the input current detector 13, and then calculates an output power correction value ΔP* by multiplying a value of the oscillation component of the input current by a predetermined coefficient. The corrector 32 calculates a voltage correction value ΔV* by dividing the output power correction value ΔP* by the output current reference I*. Then, the corrector 32 obtains an output voltage reference V1* by adding the voltage correction value ΔV* to the output voltage reference V* output from the output voltage reference generator 31.

The output voltage reference V1* that is a correction result by the corrector 32 is output to the switch driver 33. The output voltage reference V1* is obtained by adding the voltage correction value ΔV* to the output voltage reference V*, and an output voltage on which a voltage in accordance with an oscillation component of the input voltage is superposed is output from the power conversion unit 10.

In such a configuration, the matrix converter 1 according to the embodiment can reduce distortion of the input current even when the input voltage is distorted. In the following, such reduction of distortion of the input current will be further described.

The distortion of an input voltage occurs due to superposition of an oscillation component on a fundamental wave component of the input voltage. It is considered that the cause of such distortion of the input voltage is inferiority in quality of the three-phase AC power source 2, or superposition of fifth harmonics or seventh harmonics caused by large power impedance, for example.

Even when the input voltage is distorted, the controller 20 can maintain, using vector control, for example, waveforms of an output voltage and an output current in sine waves. In this case, the effective power output Pₒ is constant.

In the matrix converter 1, the effective power of the input and the effective power of the output can be considered to be equal because a large energy buffer such as a capacitor does not exist, as illustrated in FIG. 1. Then, an effective power input Pᵢ, an effective power output Pₒ, a reactive power input Qᵢ, and a reactive power output Qₒ can be expressed by following formulas (1).

Pᵢ=Pₒ=P=const

Pᵢ=VqᵢIqᵢ+VdᵢIdᵢ

Pₒ=VqₒIqₒ+VdₒIdₒ

Qᵢ=VdᵢIqᵢ−VqᵢIdᵢ

Q₀=VdₒIqₒ−VqₒIdₒ (1)

Note that subscripts “d”, “q” indicate, regarding the input side, a d-axis component and a q-axis component in a dq-axis orthogonal coordinate system rotating in synchronization with a fundamental wave frequency of an input voltage. Furthermore, in this dq-axis orthogonal coordinate system on the input side, Vdi=0 is constantly satisfied with respect to a fundamental wave of an input voltage. Regarding the output side, the subscripts “d”, “q” indicate a d-axis component and a q-axis component in a dq-axis orthogonal coordinate system rotating in synchronization with a fundamental wave frequency of the output voltage that is controlled by the controller 20 and output from the power conversion unit 10. Moreover, a subscript “i” indicates a variable on the input side, and a subscript “o” indicates a variable on the output side.

In general, the controller 20 controls a power factor of an input voltage relative to a fundamental wave to match a reference value. Regarding the d-axis component and the q-axis component on the input side, a following formula (2) is satisfied. This also applies to the case in which the input voltage is distorted.

Idᵢ/Iqᵢ=cont (constant value) (2)

An amplitude value Ia of the input current can be found by a following formula (3). Regarding the output side, both the output voltage waveform and the output current waveform are kept in sine waves with small higher harmonics by voltage output based on the instantaneous value detection results of a normal input voltage, and a current control function, for example. Thus, the effective power output Pₒ is kept constant, and the effective power input Pᵢ is also constant. When the input voltage Vqᵢ is distorted here, the input current is distorted in accordance with the distortion of the input voltage Vqᵢ in order to keep the effective power input Pᵢ constant. To be more specific, although the formula (2) mentioned above is satisfied by the controller 20, the amplitude value Ia of the input current becomes inconstant.

$$\begin{matrix}Ia = \sqrt{{Id}_{i}^{2} + {Iq}_{i}^{2}} \\ = \sqrt{\frac{{P}_{i}^{2}}{{Vq}_{i}^{2}} - \frac{2 {P}_{i} {Vd}_{i} {Id}_{i}}{{Vq}_{i}^{2}} + \frac{{Id}_{i}^{2} ( {Vq}_{i}^{2} + {Vd}_{i}^{2} )}{{Vq}_{i}^{2}}}\end{matrix} \qquad ( 3 )$$

Therefore, it is recognized that when the effective power input Pᵢ is vibrated by superposing an oscillation component on an output voltage and vibrating the effective power output Pₒ, it may be possible to reduce distortion of the input current.

Then, the controller 20 obtains the voltage correction value ΔV* in accordance with the oscillation component of the input power based on the oscillation component of the input current, as described above, outputs an output voltage to which the voltage correction value ΔV* is added, from the power conversion unit 10, and adds an oscillation component in accordance with the oscillation component of the input power to output power. Thus, the controller 20 generates distortion in the output voltage and reduces distortion of the input current.

In this manner, the matrix converter 1 according to the first embodiment reduces distortion of the input current by outputting an output voltage on which an oscillation component in accordance with the oscillation component of the input voltage is superposed from the power conversion unit 10.

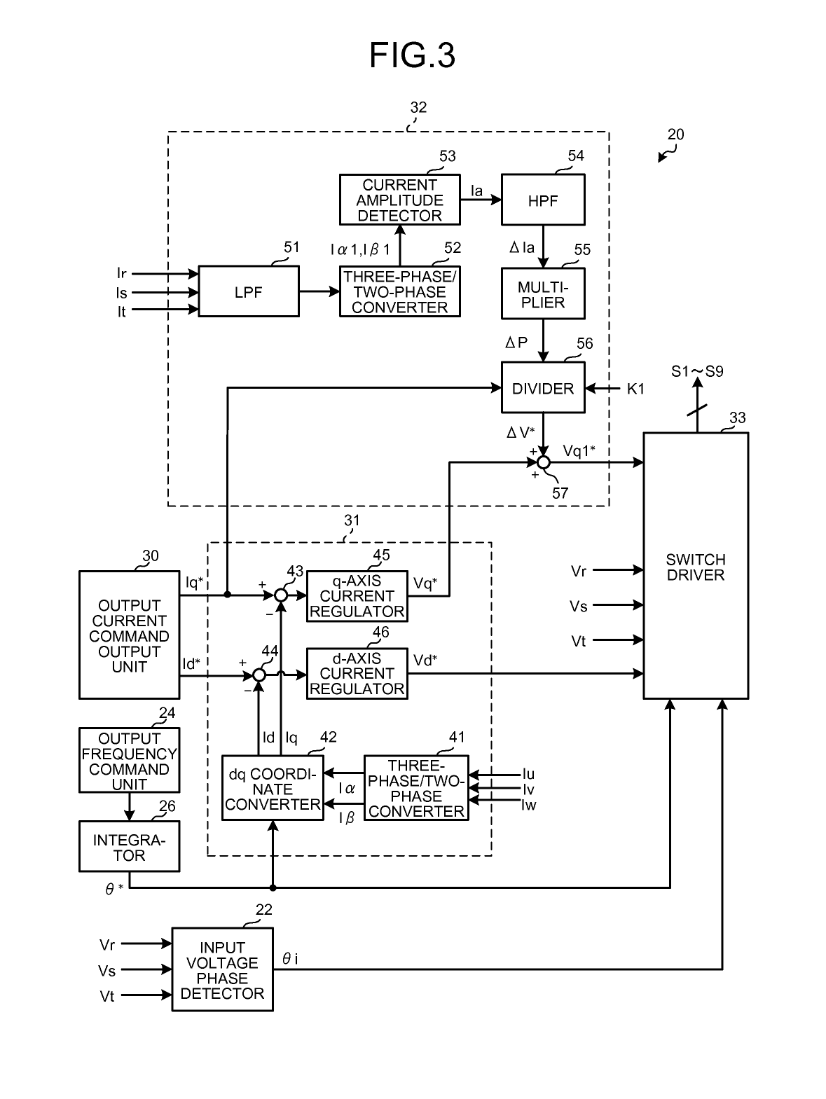

In the following, the configuration of the controller 20 will be described more specifically using the drawings. FIG. 3 is a diagram illustrating a configuration example of the controller 20 of the matrix converter 1 according to the first embodiment. Note that although the following describes an example of the case in which the AC load 3 is an AC electric motor, the AC load 3 is not limited to the electric motor.

As illustrated in FIG. 3, the controller 20 of the matrix converter 1 has an input voltage phase detector 22, an output frequency reference unit 24, an integrator 26, an output current reference generator 30, the output voltage reference generator 31, the corrector 32, and the switch driver 33.

The input voltage phase detector 22 calculates an input voltage phase θᵢ based on the input voltage values Vr, Vs, Vt detected by the input voltage detector 11. The input voltage phase detector 22 has a phase locked loop (PLL), for example. A loop gain included in the PLL is reduced, whereby it is possible to reduce sensitivity of the input voltage phase θᵢ output by the input voltage phase detector 22 relative to input voltage fluctuation. In this manner, the input voltage phase θᵢ output by the input voltage phase detector 22 becomes almost equal to a phase of a fundamental wave of the input voltage.

The output frequency reference unit 24 determines an output frequency reference that is a frequency reference of an output voltage. For example, when the AC load 3 is a synchronous electric motor, the output frequency reference unit 24 sets a frequency-converted speed reference as an output frequency reference. When the AC load 3 is an induction electric motor, the output frequency reference unit 24 determines an output frequency reference by known vector control rules for an induction electric motor.

The integrator 26 converts an output frequency reference into an output phase reference θ* by integrating the output frequency reference output by the output frequency reference unit 24.

The output current reference generator 30 generates a q-axis current reference Iq* and a d-axis current reference Id*. The q-axis current reference Iq* is a q-axis component of the output current reference I*, and the d-axis current reference Id* is a d-axis component of the output current reference I*. When the AC load 3 is an AC electric motor, the output current reference I* is generated based on a speed reference or a torque reference, or further a magnetizing reference, for example.

The output voltage reference generator 31 generates a q-axis voltage reference Vq* and a d-axis voltage reference Vd* based on the q-axis current reference Iq* and the d-axis current reference Id* output from the output current reference generator 30. The q-axis voltage reference Vq* is a q-axis component of the output voltage reference V*, and the d-axis voltage reference Vd* is a d-axis component of the output voltage reference V*.

The output voltage reference generator 31 has a three-phase/two-phase converter 41, a dq coordinate converter 42, a q-axis current deviation arithmetic unit 43, a d-axis current deviation arithmetic unit 44, a q-axis current regulator 45, and a d-axis current regulator 46.

The three-phase/two-phase converter 41 converts output current values Iu, Iv, Iw into αβ components of two orthogonal axes on fixed coordinates, and obtains a fixed coordinate current vector Iαβ having a current value Iα in an α-axial direction and a current value Iβ in a β-axial direction as vector components.

The dq coordinate converter 42 converts, using the output phase reference θ* output by the integrator 26, the fixed coordinate current vector Iαβ into dq components of a d-q coordinate system that is a two-axis orthogonal coordinate system rotating in synchronization with a frequency of the above-described output voltage reference. In this manner, the dq coordinate converter 42 obtains a rotating coordinate system current vector Idq (Id, Iq) having, as vector components, a q-axis current value Iq that is a current value in a q-axial direction and a d-axis current value Id that is a current value in a d-axial direction.

The q-axis current deviation arithmetic unit 43 calculates q-axis current deviation that is deviation between the q-axis current reference Iq* and the q-axis current value Iq and outputs it to the q-axis current regulator 45. The q-axis current regulator 45 adjusts the q-axis voltage reference Vq*, by performing proportional integral control (hereinafter described as PI control), for example, such that the deviation between the q-axis current reference Iq* and the q-axis current value Iq becomes zero, and outputs the q-axis voltage reference Vq* to the corrector 32.

The d-axis current deviation arithmetic unit 44 calculates d-axis current deviation that is deviation between the d-axis current reference Id* and the d-axis current value Id and outputs it to the d-axis current regulator 46. The d-axis current regulator 46 adjusts the d-axis voltage reference Vd*, by performing PI control, for example, such that the deviation between the d-axis current reference Id* and the d-axis current value Id becomes zero, and outputs the d-axis voltage reference Vd* to the switch driver 33.

Note that the output voltage reference generator 31 may further have a non-interference arithmetic unit not illustrated. This non-interference arithmetic unit acquires an output frequency reference from the output frequency reference unit 24 and subtracts a voltage proportional to a product of the output frequency reference and the d-axis current reference Id* or the d-axis current value Id from the output of the q-axis current regulator 45, so as to obtain the q-axis voltage reference Vq*.

Furthermore, the non-interference arithmetic unit adds a voltage proportional to a product of the output frequency reference and the q-axis current reference Iq* or the q-axis current value Iq to the output of the d-axis current regulator 46, so as to obtain the d-axis voltage reference Vd*.

Next, the corrector 32 will be described. The corrector 32 has a low pass filter (LPF) 51, a three-phase/two-phase converter 52, a current amplitude detector 53, a high pass filter (HPF) 54, a multiplier 55, a divider 56, and an adder 57. Note that the LPF 51, the three-phase/two-phase converter 52, the current amplitude detector 53, the HPF 54, and the multiplier 55 correspond to an example of a first arithmetic unit, and the divider 56 corresponds to an example of a second arithmetic unit.

The LPF 51 removes, from the input current values Ir, Is, It, high frequency components due to switching of the power conversion unit 10.

The three-phase/two-phase converter 52 converts the input current values Ir, Is, It from which high frequency components have been removed by the LPF 51 into αβ components in orthogonal two axes on fixed coordinates, and obtains a current value Iα1 in an α-axial direction and a current value Iβ1 in a β-axial direction.

The current amplitude detector 53 performs calculation of a following formula (4) using the current value Iα1 and the current value Iβ1 to detect an amplitude value Ia of the input current.

Ia=\sqrt{Iα1²+Iβ1²} (4)

The HPF 54 removes a fundamental wave component of the input current from the amplitude value Ia of the input current output from the current amplitude detector 53, and extracts an oscillation component ΔIa of the input current. The multiplier 55 multiplies the oscillation component ΔIa of the input current extracted by the HPF 54 by a coefficient K1 to obtain an output power correction value ΔP. Note that the coefficient K1 can be set externally to a value in accordance with a use or an installation environment of the matrix converter 1, and the coefficient K1 can be set so that the output power correction value ΔP is substantially the same as an oscillation component of the input power or so that the output power correction value ΔP is of a predetermined proportion (50%, for example) of the oscillation component of the input power, for example.

Here, a cutoff frequency f_{LPF} of the LPF 51 and a cutoff frequency f_{HPF} of the HPF 54 are determined so as to satisfy the relation of f_{LPF}>f_{HPF}. In this manner, it is possible to obtain, as an output of the HPF 54, only high frequency components due to distortion of the input voltage from which high frequency components due to switching of the power conversion unit 10 have been removed.

The output power correction value ΔP calculated by the multiplier 55 is input to the divider 56. The divider 56 divides the output power correction value ΔP by the q-axis current reference Iq* output from the output current reference generator 30 to calculate the voltage correction value ΔV* (=ΔP/Iq*).

The adder 57 adds the voltage correction value ΔV* output from the divider 56 to the q-axis voltage reference Vq* output from the output voltage reference generator 31 to calculate a q-axis voltage reference Vq1*. The adder 57 outputs the q-axis voltage reference Vq1* to the switch driver 33.

The switch driver 33 generates drive signals S1 to S9 driving the bidirectional switches SW1 to SW9 based on the q-axis voltage reference Vq1* output from the corrector 32 and the d-axis voltage reference Vd* output from the output voltage reference generator 31.

For example, the switch driver 33 obtains, based on the q-axis voltage reference Vq1* and the d-axis voltage reference Vd*, the output voltage reference V1* and the output voltage phase reference θa* using following formulas (5), for example. Moreover, the switch driver 33 adds the output phase reference θ* that is output of the integrator 26 to the output voltage phase reference θa* to obtain a phase θp.

V1*=\sqrt{Vd*²+Vq1*²}

θa*=tan⁻¹(Vq1*/Vd*) (5)

Then, the switch driver 33 obtains, based on the output voltage reference V1* and the phase θp, a three-phase AC voltage reference, that is, output voltage references Vu*, Vv*, Vw* for the phases of the AC load 3, using following formulas (6), for example.

Vu*=V1*×sin(θp)

Vv*=V1*×sin(θp−(2π/3))

Vw*=V1*×sin(θp+(2π/3)) (6)

The switch driver 33 generates, based on the output voltage references Vu*, Vv*, Vw*, the input voltage values Vr, Vs, Vt, and the input voltage phase θᵢ, drive signals S1 to S9 for controlling the respective bidirectional switches SW1 to SW9 of the power conversion unit 10 by a known pulse width modulation method for a matrix converter, and outputs the drive signals S1 to S9. In this manner, the three-phase AC voltage in accordance with the output voltage references Vu*, Vv*, Vw* is output from the power conversion unit 10. Furthermore, the phase of the input current is controlled to have a predetermined phase difference relative to the input voltage phase θᵢ, and the power factor on the input side becomes a constant value.

The output correction value in accordance with the oscillation component of the input power is added in the output voltage references Vu*, Vv*, Vw*. Thus, an oscillation component in accordance with the oscillation component of the input power is superposed on the output voltage from the power conversion unit 10, and the effective power output Pₒ is fluctuated.

As described above, the effective power input Pᵢ and the effective power output Pₒ are equal (refer to formula (1) mentioned above). Thus, when an oscillation component in accordance with an oscillation component of the input voltage occurs in the effective power output Pₒ, the oscillation component occurs also in the effective power input Pᵢ in the same manner. The oscillation component of the effective power input Pᵢ corresponds to an oscillation component of the input voltage, and thus the distortion of the input current is reduced. Therefore, the coefficient K1 is set such that the oscillation component of the output power is substantially the same as the oscillation component of the input voltage, whereby the input current can be maintained in a substantially sine wave.

### Second Embodiment

Next, a controller of a matrix converter according to the second embodiment will be described. In the controller 20 according to the first embodiment, the voltage correction value ΔV* is added to the q-axis voltage reference Vq*. In the controller according to the second embodiment, the voltage correction value ΔV* is added to the d-axis voltage reference Vd*. Note that in the following, a part different from the first embodiment will be mainly described, and the common parts are represented with same symbols and the description is omitted appropriately.

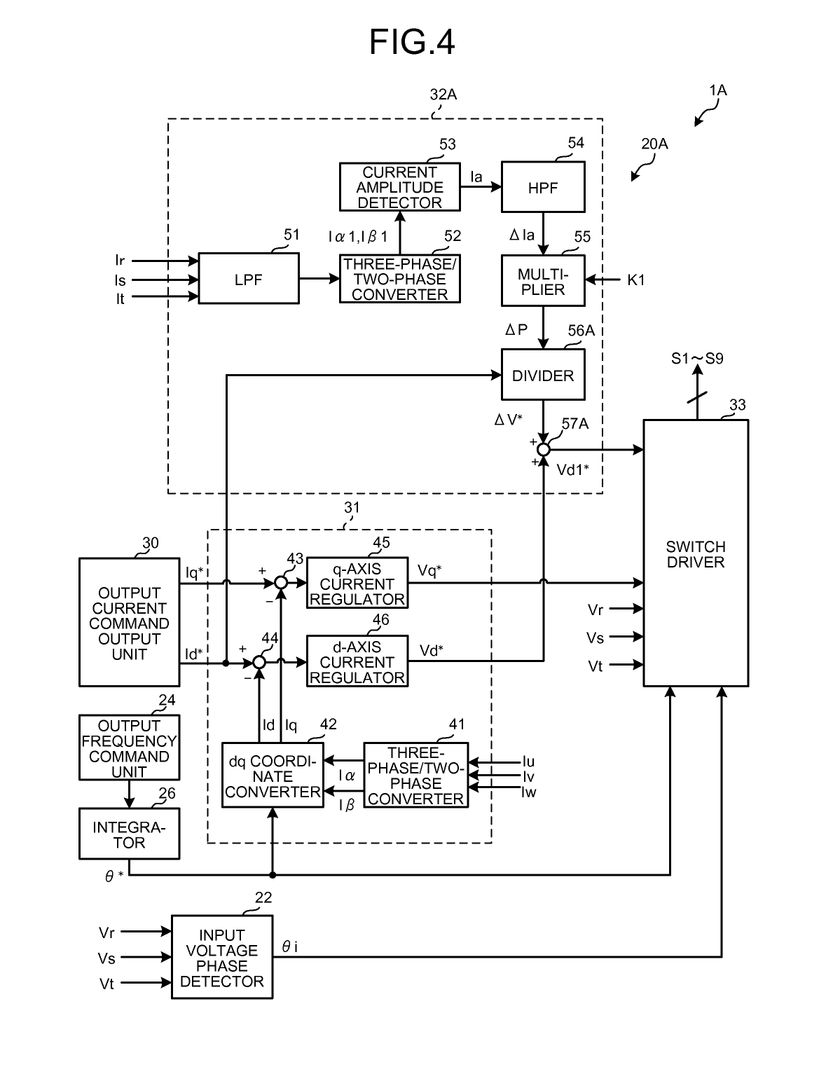

FIG. 4 is a diagram illustrating a configuration example of the controller of the matrix converter according to the second embodiment. In a controller 20A of a matrix converter 1A according to the second embodiment, a corrector 32A performs correction of the d-axis voltage reference Vd* using the voltage correction value ΔV*.

As illustrated in FIG. 4, the corrector 32A has the LPF 51, the three-phase/two-phase converter 52, the current amplitude detector 53, the HPF 54, the multiplier 55, a divider 56A, and an adder 57A. The LPF 51, the three-phase/two-phase converter 52, the current amplitude detector 53, the HPF 54, and the multiplier 55 have the same configuration as the case of the corrector 32.

The divider 56A divides the output power correction value ΔP by the d-axis current reference Id* output from the output current reference generator 30 to calculate the voltage correction value ΔV* (=ΔP/Id*).

The adder 57A adds the voltage correction value ΔV* output from the divider 56A to the d-axis voltage reference Vd* output from the output voltage reference generator 31 to calculate the d-axis voltage reference Vd1*. Then, the adder 57A outputs the d-axis voltage reference Vd1* to the switch driver 33. The switch driver 33 generates drive signals S1 to S9 based on such d-axis voltage reference Vd1* and q-axis voltage reference Vq*.

It is needless to say that the oscillation component in accordance with an oscillation component of the input voltage can be superposed on the output voltage by correction of a d-axis component of the output voltage instead of correction of a q-axis component of the output voltage.

Therefore, also in the matrix converter 1A according to the second embodiment, the distortion of the input current can be reduced even when the input voltage is distorted, similarly to the matrix converter 1 according to the first embodiment.

### Third Embodiment

Next, a controller of a matrix converter according to the third embodiment will be described. The controllers 20, 20A according to the first and second embodiments calculate the voltage correction value ΔV* in accordance with an oscillation component of an input current. The controller according to the third embodiment calculates the voltage correction value in accordance with an oscillation component of an input voltage. Note that in the following, a part different from the first and second embodiments will be mainly described, and the common parts are represented with same symbols and the description is omitted appropriately.

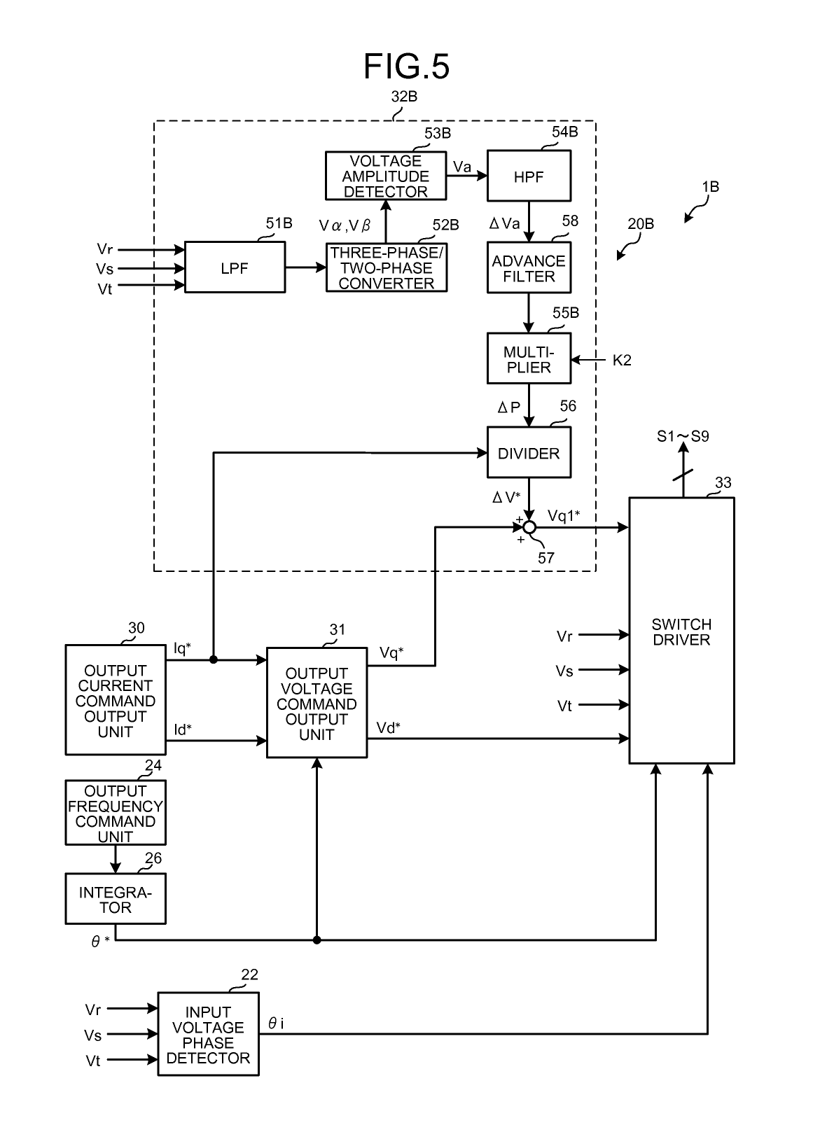

FIG. 5 is a diagram illustrating a configuration example of the controller of the matrix converter according to the third embodiment. In a controller 20B of a matrix converter 1B according to the third embodiment, a corrector 32B generates a voltage correction value in accordance with an oscillation component of an input voltage.

As illustrated in FIG. 5, the corrector 32B has an LPF 51B, a three-phase/two-phase converter 52B, a voltage amplitude detector 53B, an HPF 54B, a multiplier 55B, the divider 56, the adder 57, and an advance filter 58.

The LPF 51B removes high frequency components due to switching of the power conversion unit 10 from the input voltage values Vr, Vs, Vt.

The three-phase/two-phase converter 52B converts the input voltage values Vr, Vs, Vt from which high frequency components have been removed by the LPF 51B into αβ components in orthogonal two axes on fixed coordinates, and obtains a voltage value Vu in an α-axial direction and a voltage value Vβ in a β-axial direction.

The voltage amplitude detector 53B performs calculation of a following formula (7) using the voltage value Vα and the voltage value Vβ to detect an amplitude value Va of the input voltage.

Va=\sqrt{Vα²+Vβ²} (7)

The HPF 54B removes a fundamental wave component of the input voltage from the amplitude value Va of the input voltage output from the voltage amplitude detector 53B, and extracts an oscillation component ΔVa of the input voltage. The advance filter 58 advances a phase of the oscillation component ΔVa of the input voltage extracted by the HPF 54B by 90° and outputs it to the multiplier 55B. The oscillation component ΔVa of the input voltage is converted into a value in accordance with the oscillation component of the input current by advancing the phase of the oscillation component ΔVa of the input voltage by 90°.

The multiplier 55B multiplies the oscillation component ΔVa of the input voltage whose phase has been advanced by 90° by the advanced filter 58 by a coefficient K2 to obtain the output power correction value ΔP. The coefficient K2 is set so that the output power correction value ΔP is substantially the same as the oscillation component of the input power, for example. Note that the coefficient K2 can be set externally to a value in accordance with a use and an installation environment of the matrix converter 1B, and the coefficient K2 can be also set so that the output power correction value ΔP corresponds to a predetermined proportion (50%, for example) of the oscillation component of the input power.

The output power correction value ΔP calculated by the multiplier 55B is input to the divider 56. The divider 56 divides the output power correction value ΔP by the q-axis current reference Iq* output from the output current reference generator 30 to calculate the voltage correction value ΔV* (=ΔP/Iq*).

The adder 57 adds the voltage correction value ΔV* output from the divider 56 to the q-axis voltage reference Vq* output from the output voltage reference generator 31 to calculate the q-axis voltage reference Vq1*. The adder 57 outputs the q-axis voltage reference Vq1* to the switch driver 33.

In this manner, the matrix converter 1B according to the third embodiment calculates the output power correction value ΔP based on the oscillation component of the input voltage, and calculates the voltage correction value ΔV* based on the output power correction value ΔP.

Therefore, in the matrix converter 1B according to the third embodiment, the distortion of the input current can be reduced even when the input voltage is distorted, similarly to the matrix converter 1 according to the first embodiment. For example, the coefficient K2 is set such that the output power correction value ΔP is substantially the same as the oscillation component of the input power, whereby the input current can be maintained in a substantially sine wave.

Note that although the voltage correction value ΔV* is added to the q-axis voltage reference Vq* in the above-described configuration, the voltage correction value ΔV* may be added to the d-axis voltage reference Vd*, similarly to the matrix converter 1A according to the second embodiment.

### Fourth Embodiment

Next, a controller of a matrix converter according to the fourth embodiment will be described. The controllers 20, 20A, 20B according to the first to third embodiments are configured to calculate the voltage correction value ΔV* in accordance with an oscillation component of an input current or an input voltage. By contrast, the controller according to the fourth embodiment calculates the voltage correction value ΔV* in accordance with an oscillation component of an input current and an oscillation component of an input voltage. In the following, a part different from the first embodiment will be mainly described, and the common parts are represented with same symbols and the description is omitted appropriately.

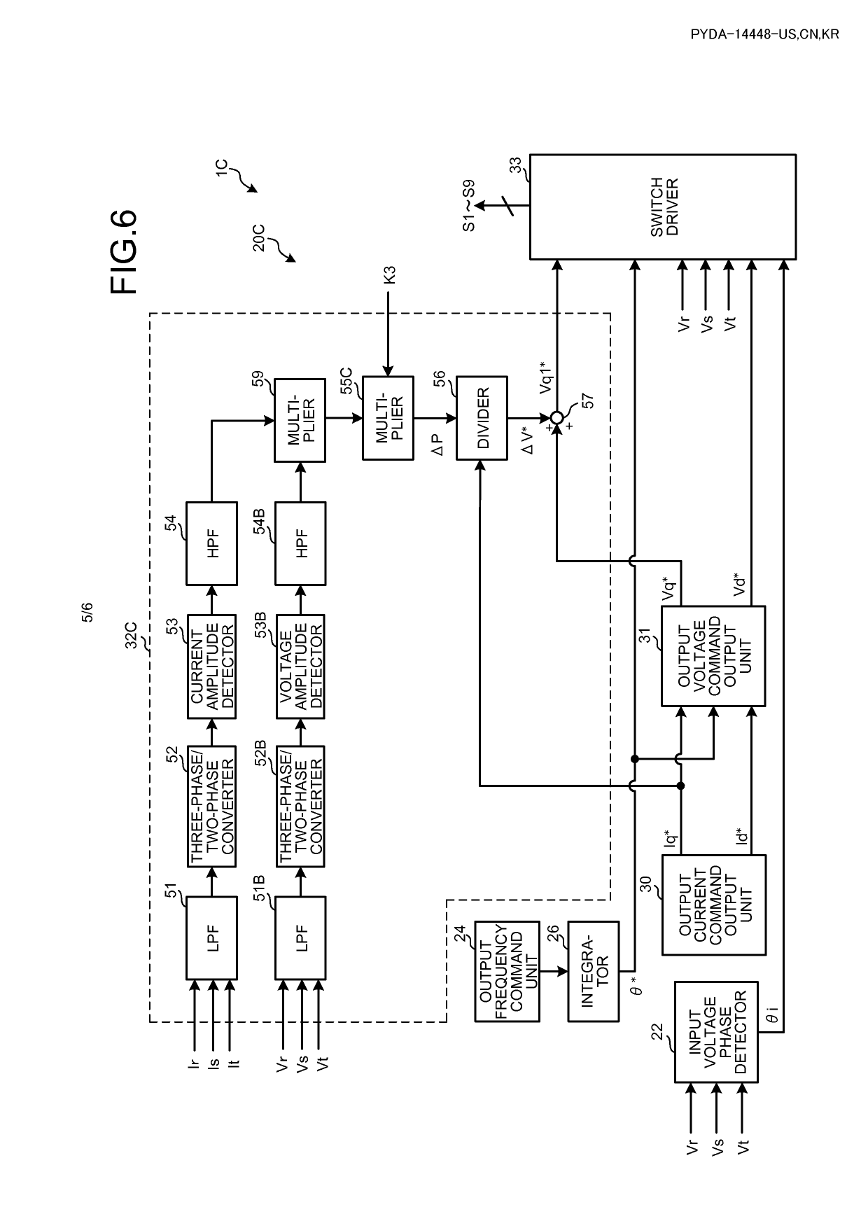

FIG. 6 is a diagram illustrating a configuration example of the controller of the matrix converter according to the fourth embodiment. In a controller 20C of a matrix converter 1C according to the fourth embodiment, a corrector 32C generates a voltage correction value in accordance with an oscillation component of an input current and an oscillation component of an input voltage.

As illustrated in FIG. 6, the corrector 32C has the LPFs 51, 51B, the three-phase/two-phase converters 52, 52B, the current amplitude detector 53, the voltage amplitude detector 53B, the HPFs 54, 54B, the multipliers 59, 55C, the divider 56, and the adder 57.

In the corrector 32C, the amplitude of an input current is extracted by the LPF 51, the three-phase/two-phase converter 52, the current amplitude detector 53, and the HPF 54, and the amplitude of an input voltage is extracted by the LPF 51B, the three-phase/two-phase converter 52B, the voltage amplitude detector 53B, and the HPF 54. Note that the cutoff frequencies of the HPFs 54, 54B are made equal to each other, whereby it is possible to accurately generate the voltage correction value ΔV in the corrector 32C.

The multiplier 59 multiplies the oscillation component of the input current extracted by the HPF 54 and the oscillation component of the input voltage extracted by the HFP 54B. In this manner, the oscillation component of the input power can be extracted.

The multiplier 55C multiplies the multiplication result by the multiplier 59 by a coefficient K3. The coefficient K3 can be set externally to a value in accordance with a use or an installation environment of the matrix converter 1C, and the coefficient K3 is set to “1”, for example, when the output power correction value ΔP is made substantially the same as the oscillation component of the input power, for example. Moreover, when the output power correction value ΔP is set to correspond to a predetermined proportion (50%, for example) of the oscillation component of the input power, a value in accordance with the proportion is set as the coefficient K3.

The divider 56 divides the output power correction value ΔP by the q-axis current reference Iq* output from the output current reference generator 30 to calculate the voltage correction value ΔV* (=ΔP/Iq*). The adder 57 adds the voltage correction value ΔV* output from the divider 56 to the q-axis voltage reference Vq* output from the output voltage reference generator 31 to calculate the q-axis voltage reference Vq1*. The adder 57 outputs the q-axis voltage reference Vq1* to the switch driver 33.

In this manner, the matrix converter 1C according to the fourth embodiment calculates the output power correction value ΔP in accordance with the oscillation component of the input current and the oscillation component of the input voltage, and calculates the voltage correction value ΔV* based on the output power correction value ΔP. Therefore, the matrix converter 1C can superpose the oscillation component in accordance with the oscillation component of the input voltage on the output voltage, similarly to the matrix converters 1, 1A, 1B, and thus can reduce distortion of the input current even when the input voltage is distorted. For example, the coefficient K3 is set to “1”, whereby the input current can be maintained in a substantially sine wave.

Note that although the voltage correction value ΔV* is added to the q-axis voltage reference Vq* in the configuration described above, the voltage correction value ΔV* may be added to the d-axis voltage reference Vd*, similarly to the matrix converter 1A according to the second embodiment.

### Fifth Embodiment

Next, a controller of a matrix converter according to the fifth embodiment will be described. In the controllers 20, 20A to 20C according to the first to fourth embodiments, the coefficients K1 to K3 can be set externally in the multipliers 55, 55B, 55C. By contrast, in the controller according to the fifth embodiment, a reference value of an oscillation component of an input current can be set. Note that in the following, a part different from the first embodiment will be mainly described, and the common parts are represented with same symbols and the description is omitted appropriately.

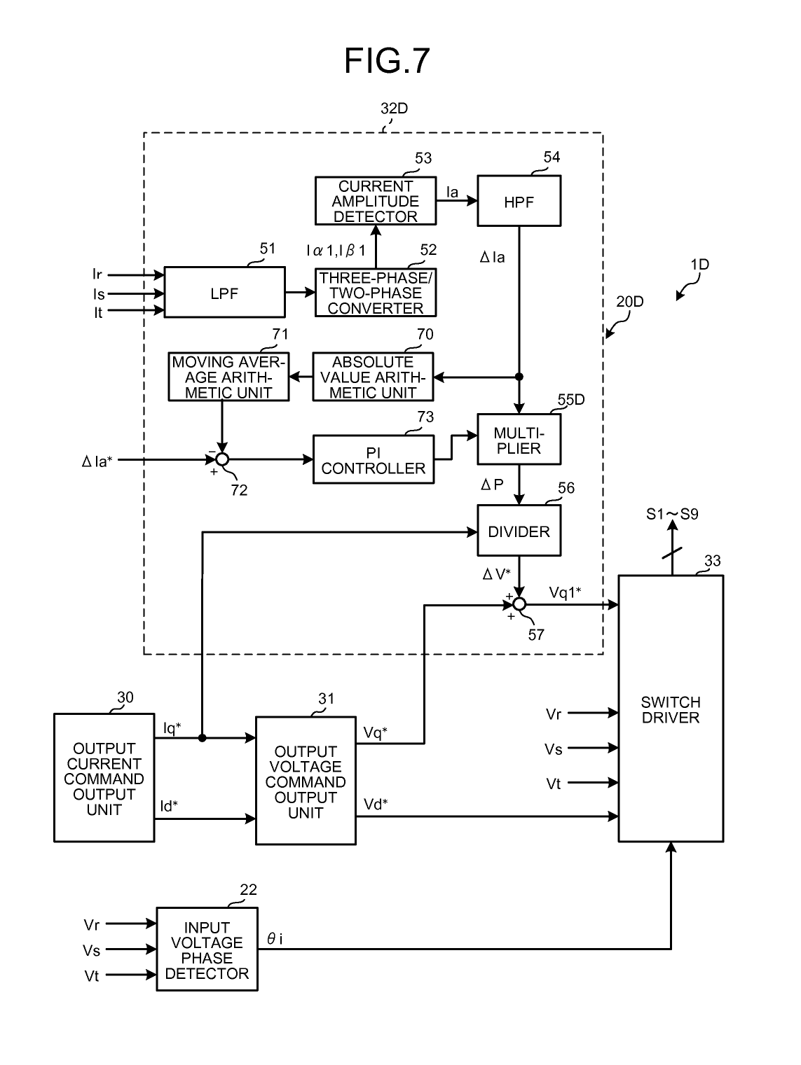

FIG. 7 is a diagram illustrating a configuration example of the controller of the matrix converter according to the fifth embodiment. In a controller 20D of a matrix converter 1D according to the fifth embodiment, a corrector 32D can adjust a coefficient K4 of a multiplier 55D.

To be more specific, the corrector 32D has an absolute value arithmetic unit 70, a moving average arithmetic unit 71, a subtractor 72, and a PI controller 73, in addition to the components of the corrector 32 according to the first embodiment. The absolute value arithmetic unit 70 calculates an absolute value |ΔIa| of the oscillation component ΔIa of the input current extracted by the HPF 54. The moving average arithmetic unit 71 obtains a moving average of the absolute values |ΔIa| that is a calculation result of the absolute value arithmetic unit 70.

The subtractor 72 calculates a difference between the reference value Ia* of the oscillation component of the input current input externally and the moving average of the absolute values |ΔIa|, and outputs it to the PI controller 73. The PI controller 73 adjusts the coefficient K4 of the multiplier 55D, by performing PI control, for example, such that the deviation between the reference value Ia* of the oscillation component of the input current and the moving average of the absolute values |ΔIa| is zero.

The multiplier 55D is an arithmetic unit corresponding to the multiplier 55, and outputs, as the output power correction value ΔP, a result obtained by multiplying the oscillation component ΔIa of the input current by the coefficient K4 to the divider 56. Therefore, the matrix converter 1D according to the fifth embodiment can set the oscillation component ΔIa of the input current to a value in accordance with the reference value Ia*, and thus can reduce distortion of the input current.

According to the embodiments, it is possible to provide a matrix converter capable of reducing distortion of an input current due to distortion of an input voltage.

The further effects and modifications can be derived easily by a person skilled in the art. Thus, the broader forms of the present invention are not limited to the predetermined details and representative embodiments that are illustrated and described as above. Therefore, various modifications are possible without departing from the integrated spirit and scope of the concept of the invention defined by the appended claims and the equivalents.

What is claimed is:

1. A matrix converter comprising:
a plurality of bidirectional switches that are disposed between an alternating current (AC) power source and an AC load; and
a controller that controls the bidirectional switches to directly convert an input power input from the AC power source into an output power to be output to the AC load, wherein
the controller includes
an output voltage reference generator that generates an output voltage reference defining an output voltage to be output to the AC load,
a corrector that corrects the output voltage reference based on an oscillation component of an input current and/or an input voltage input from the AC power source, and
a switch driver that controls the bidirectional switches based on the output voltage reference corrected by the corrector.

2. The matrix converter according to claim 1, wherein
the corrector includes
a first arithmetic unit that calculates an output power correction value based on the oscillation component of the input current and/or the input voltage,
a second arithmetic unit that calculates a voltage correction value according to the output power correction value, and
an adder that corrects the output voltage reference by adding the voltage correction value generated by the second arithmetic unit to the output voltage reference.

3. The matrix converter according to claim 2, wherein the second arithmetic unit calculates the voltage correction value by dividing the output power correction value calculated by the first arithmetic unit by an output current reference defining an output current to be output to the AC load.

4. The matrix converter according to claim 3, wherein the first arithmetic unit calculates the output power correction value by multiplying the oscillation component of the input current by a predetermined coefficient.

5. The matrix converter according to claim 3, wherein the first arithmetic unit advances a phase of the oscillation component of the input voltage, and calculates the output power correction value by multiplying the phase-advanced oscillation component by a predetermined coefficient.

6. The matrix converter according to claim 3, wherein the first arithmetic unit calculates the output power correction value by multiplying the oscillation component of the input current and the oscillation component of the input voltage.

7. The matrix converter according to claim 6, wherein the first arithmetic unit calculates the output power correction value by multiplying a multiplication result of the oscillation component of the input current and the oscillation component of the input voltage by a predetermined coefficient.

8. The matrix converter according to claim 4, wherein the predetermined coefficient is set from an outside in the first arithmetic unit.

9. The matrix converter according to claim 4, further comprising an adjustment unit that adjusts the predetermined coefficient.

10. The matrix converter according to claim 1, wherein
the output voltage reference generator generates, as the output voltage references, a q-axis voltage reference and a d-axis voltage reference on d-q axes in a two-axis orthogonal coordinate system rotating in synchronization with a frequency of the output voltage, and
the corrector corrects the q-axis voltage reference or the d-axis voltage reference based on the oscillation component of the input current and/or the input voltage.

11. A method for controlling a matrix converter, the method comprising:
generating an output voltage reference defining an output voltage to be output to an AC load;
correcting the output voltage reference based on any one of or both of an oscillation component of an input current and an input voltage input from an AC power source; and
controlling a plurality of bidirectional switches, which are disposed between the AC power source and the AC load, based on the corrected output voltage reference.
